(19) United States
(12) Patent Application Publication
(10) Pub. No.: US 2026/0249607 A1
(43) Pub. Date: Aug. 27, 2026

(54) TRANSFER MACHINE AND TRANSFER METHOD

(71) Applicant: SEIKO EPSON CORPORATION, Tokyo (JP)

(72) Inventor: Yohei SHIBATA, SHIOJIRI-SHI (JP)

(21) Appl. No.: 19/546,663

(22) Filed: Feb. 23, 2026

(30) Foreign Application Priority Data
Feb. 25, 2025 (JP) 2025-027966

(51) Int. Cl. B41F 16/00

(52) U.S. Cl. CPC B41F 16/0026; B41F 16/0093

(57) ABSTRACT

There is provided a transfer machine that transfers an image formed on a first transfer surface of a first transfer sheet with a sublimation ink to a front surface of a medium and transfers an image formed on a second transfer surface of a second transfer sheet with a sublimation ink to a back surface of the medium, and the transfer machine includes: a heating unit that heats the first transfer sheet and the second transfer sheet sandwiching the medium in a stacking section in which a first path through which the first transfer sheet is conveyed, a second path through which the second transfer sheet is conveyed, and a third path through which the medium is conveyed overlap each other; and a detection unit that detects an amount of meandering of the first transfer sheet and the second transfer sheet before being heated by the heating unit.

The present application is based on, and claims priority from JP Application Serial Number 2025-027966, filed February 25, 2025, the disclosure of which is hereby incorporated by reference herein in its entirety.

### BACKGROUND

### 1. Technical Field

The present disclosure relates to a transfer machine and a transfer method.

### 2. Related Art

For example, as in JP-A-10-237775, there is a textile printing device as an example of a transfer machine that performs transfer to a fabric as an example of a medium. The textile printing device includes a pressing felt, and a thermal cylinder which is an example of a heating unit. The textile printing device forms a multilayer sheet by sandwiching a fabric between a first transfer paper as an example of a first transfer sheet and a second transfer paper as an example of a second transfer sheet. The textile printing device passes the multilayer sheet between the pressing felt and the thermal cylinder and thus transfers a sublimation dye printed on the first transfer paper and the second transfer paper to the two sides of the fabric.

JP-A-10-237775 is an example of the related art.

Each of the first transfer sheet, the second transfer sheet, and the medium is long. Therefore, the first transfer sheet, the second transfer sheet, and the medium may meander while being conveyed. However, for example, when the first transfer sheet meanders or the first transfer sheet and the second transfer sheet meander in different periods or sizes, the first transfer sheet, the second transfer sheet, and the medium overlap each other in a misaligned state. When the positions of the first transfer sheet and the second transfer sheet are misaligned in relation to the medium, the images transferred to the front surface and the back surface of the medium are misaligned from each other.

### SUMMARY

According to an aspect of the present disclosure, there is provided a transfer machine that transfers an image formed on a first transfer surface of a first transfer sheet with a sublimation ink to a front surface of a medium and transfers an image formed on a second transfer surface of a second transfer sheet with a sublimation ink to a back surface of the medium, and the transfer machine includes: a heating unit that heats the first transfer sheet and the second transfer sheet sandwiching the medium in a stacking section in which a first path through which the first transfer sheet is conveyed, a second path through which the second transfer sheet is conveyed, and a third path through which the medium is conveyed overlap each other; and a detection unit that detects an amount of meandering of the first transfer sheet and the second transfer sheet before being heated by the heating unit.

According to another aspect of the present disclosure, there is provided a transfer method of transferring an image formed on a first transfer surface of a first transfer sheet with a sublimation ink to a front surface of a medium and transferring an image formed on a second transfer surface of a second transfer sheet with a sublimation ink to a back surface of the medium, and the transfer method includes: heating the first transfer sheet and the second transfer sheet sandwiching the medium in a stacking section in which at least a part of a first path through which the first transfer sheet is conveyed, a part of a second path through which the second transfer sheet is conveyed, and a part of a third path through which the medium is conveyed overlap each other; and detecting an amount of meandering of the first transfer sheet and the second transfer sheet before being heated by a heating unit.

### BRIEF DESCRIPTION OF THE DRAWINGS

FIG. 1 is a schematic view of a first embodiment of a transfer machine.

FIG. 2 is a schematic view of a second embodiment of the transfer machine.

### DESCRIPTION OF EMBODIMENTS

### First Embodiment

Hereinafter, a first embodiment of a transfer machine and a transfer method will be described with reference to the drawings. The transfer machine is, for example, a calendar machine that performs sublimation transfer of an image formed on a transfer sheet to a medium such as a paper, a fabric, or a vinyl sheet.

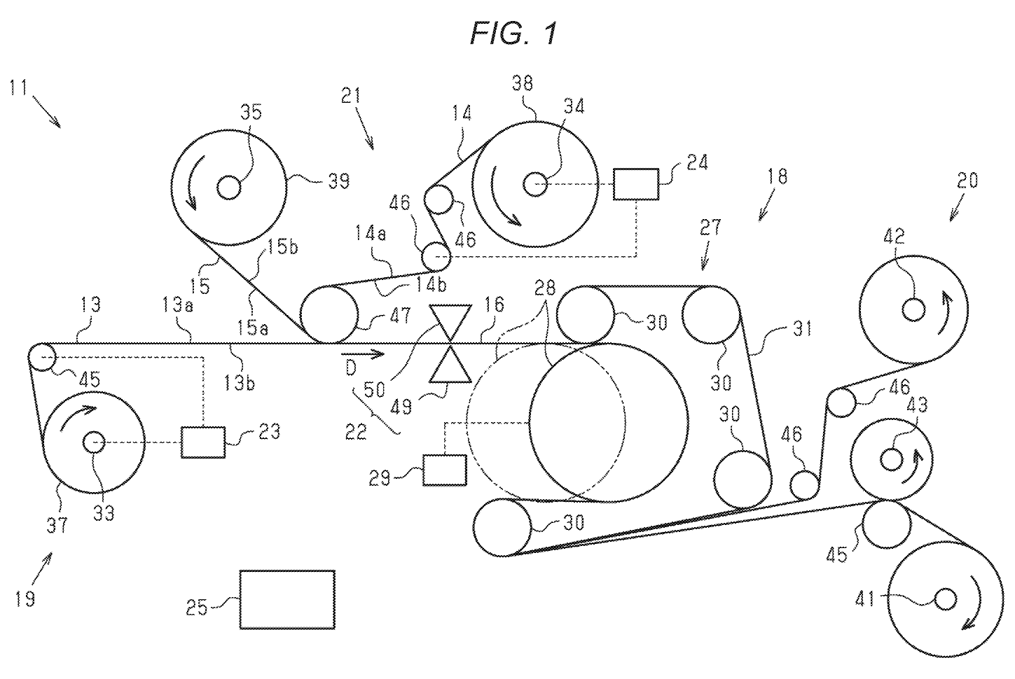

As illustrated in FIG. 1, a transfer machine 11 handles a first transfer sheet 13, a second transfer sheet 14, and a medium 15. In the present embodiment, the first transfer sheet 13 and the second transfer sheet 14 sandwiching the medium 15 are also referred to as a multilayer body 16.

The first transfer sheet 13 has a first transfer surface 13a and a first non-transfer surface 13b. An image is formed on the first transfer surface 13a with a sublimation ink. The first non-transfer surface 13b is a surface opposite to the first transfer surface 13a. No image is formed on the first non-transfer surface 13b with a sublimation ink. The first transfer sheet 13 is long.

The second transfer sheet 14 has a second transfer surface 14a and a second non-transfer surface 14b. An image is formed on the second transfer surface 14a with a sublimation ink. The second non-transfer surface 14b is a surface opposite to the second transfer surface 14a. No image is formed on the second non-transfer surface 14b with a sublimation ink. The second transfer sheet 14 is long.

The medium 15 has a front surface 15a and a back surface 15b. The front surface 15a is a surface to which the image on the first transfer sheet 13 is transferred. The back surface 15b is a surface opposite to the front surface 15a. The back surface 15b is a surface to which the image on the second transfer sheet 14 is transferred. The medium 15 is long.

### Transfer Machine

The transfer machine 11 may include a transfer unit 18, a feeding unit 19, a collection unit 20, and a conveyance unit 21. The transfer machine 11 may include a detection unit 22, a first adjustment unit 23, a second adjustment unit 24, and a control unit 25.

The transfer unit 18 may include a pressing unit 27, a heating unit 28, and a separation unit 29.

The pressing unit 27 presses the multilayer body 16 against the heating unit 28. The pressing unit 27 may include a plurality of pulleys 30 and a pressing belt 31.

The plurality of pulleys 30 are configured to rotate. Of the plurality of pulleys 30, one pulley 30 is configured to rotate for driving, and the other pulleys 30 are configured to be driven to rotate.

The pressing belt 31 has an annular shape. The pressing belt 31 is wound around the plurality of pulleys 30. The pressing belt 31 rotates in the counterclockwise direction in FIG. 1 as the one pulley 30 rotates for driving.

The heating unit 28 may be a roller that can rotate in the clockwise direction in FIG. 1. The heating unit 28 may include a built-in heater. The multilayer body 16 is wound around the heating unit 28. The heating unit 28 and the pressing belt 31 sandwich the multilayer body 16. The heating unit 28 heats the multilayer body 16.

The rotating heating unit 28 and the circulating pressing belt 31 convey the multilayer body 16. The heating unit 28 and the pressing unit 27 are configured to convey the multilayer body 16 while heating and pressurizing the multilayer body 16. The heating unit 28 and the pressing unit 27 transfer the image formed on the first transfer sheet 13 to the front surface 15a of the medium 15 and transfer the image formed on the second transfer sheet 14 to the back surface 15b of the medium 15.

The separation unit 29 separates the heating unit 28 and the pressing unit 27. The separation unit 29 moves at least one of the heating unit 28 and the pressing unit 27. The separation unit 29 may move one or more pulleys 30. The separation unit 29 in the present embodiment moves the heating unit 28 from a transfer position indicated by a solid line in FIG. 1 to a separation position indicated by the two-dot chain line in FIG. 1 and thus separates the heating unit 28 from the pressing unit 27. As the heating unit 28 is moved to the separation position, the multilayer

body 16 can be easily set between the heating unit 28 and the pressing unit 27 in a state where the misalignment of the first transfer sheet 13, the medium 15, and the second transfer sheet 14 is suppressed.

The feeding unit 19 may include a first feeding unit 33, a second feeding unit 34, and a third feeding unit 35.

The first feeding unit 33 can hold a first roll body 37 formed of the first transfer sheet 13 before transfer that is wound. The first feeding unit 33 rotates the first roll body 37 in the clockwise direction in FIG. 1. The first feeding unit 33 feeds the first transfer sheet 13 from the first roll body 37.

The second feeding unit 34 can hold a second roll body 38 formed of the second transfer sheet 14 before transfer that is wound. The second feeding unit 34 rotates the second roll body 38 in the counterclockwise direction in FIG. 1. The second feeding unit 34 feeds the second transfer sheet 14 from the second roll body 38.

The third feeding unit 35 can hold a third roll body 39 of the medium 15 before transfer that is wound. The third feeding unit 35 rotates the third roll body 39 in the counterclockwise direction in FIG. 1. The third feeding unit 35 feeds the medium 15 from the third roll body 39.

The collection unit 20 may include a first take-up unit 41, a second take-up unit 42, and a third take-up unit 43.

The first take-up unit 41 collects the first transfer sheet 13. The first take-up unit 41 can hold the first transfer sheet 13 after the transfer. The first take-up unit 41 may rotate in the clockwise direction in FIG. 1 and thus wind up the first transfer sheet 13 into a roll shape.

The second take-up unit 42 collects the second transfer sheet 14. The second take-up unit 42 can hold the second transfer sheet 14 after the transfer. The second take-up unit 42 may rotate in the counterclockwise direction in FIG. 1 and thus wind up the second transfer sheet 14 into a roll shape.

The third take-up unit 43 collects the medium 15. The third take-up unit 43 can hold the medium 15 after the transfer. The third take-up unit 43 may rotate in the counterclockwise direction in FIG. 1 and thus wind up the medium 15 into a roll shape.

Here, a path through which the first transfer sheet 13 is conveyed is defined as a first path. In FIG. 1, the first path is a path from the first feeding unit 33 to the first take-up unit 41. A path through which the second transfer sheet 14 is conveyed is defined as a second path. In FIG. 1, the second path is a path from the second feeding unit 34 to the second take-up unit 42. A path through which the medium 15 is conveyed is defined as a third path. In FIG. 1, the third path is a path from the third feeding unit 35 to the third take-up unit 43. A section in which the first path, the second path, and the third path overlap each other is defined as a stacking section. The stacking section is a section in which the first transfer sheet 13, the second transfer sheet 14, and the medium 15 are conveyed through the same path.

The conveyance unit 21 may include one or more first conveyance rollers 45, one or more second conveyance rollers 46, and a stacking unit 47.

The first conveyance roller 45 conveys the first transfer sheet 13 in a conveyance direction D along the first path. The first conveyance roller 45 feeds the first transfer sheet 13 fed from the first feeding unit 33 to the first take-up unit 41. The first transfer sheet 13 is wound around the first conveyance roller 45. The first conveyance roller 45 may apply a tension to the first transfer sheet 13. The first conveyance roller 45 may convey the first transfer sheet 13 by rotating. The first conveyance roller 45 may be driven to rotate by the conveyed first transfer sheet 13.

The second conveyance roller 46 conveys the second transfer sheet 14 in the conveyance direction D along the second path. The second conveyance roller 46 feeds the second transfer sheet 14 fed from the second feeding unit 34 to the second take-up unit 42. The second transfer sheet 14 is wound around the second conveyance roller 46. The second conveyance roller 46 may apply a tension to the second transfer sheet 14. The second conveyance roller 46 may convey the second transfer sheet 14 by rotating. The second conveyance roller 46 may be driven to rotate by the conveyed second transfer sheet 14.

The stacking unit 47 may be a rotating roller. The stacking unit 47 is provided upstream of the transfer unit 18 in the conveyance direction D. The stacking unit 47 stacks the first transfer sheet 13, the medium 15, and the second transfer sheet 14 such that the medium 15 is sandwiched between the first transfer sheet 13 and the second transfer sheet 14. The stacking unit 47 may stack the first transfer sheet 13, the medium 15, and the second transfer sheet 14 in order. The stacking unit 47 forms the multilayer body 16. In FIG. 1, a section from a part where formation of the multilayer body 16 is started by the stacking unit 47 to a part where the multilayer body 16 is wound around one pulley 30 of the plurality of pulleys 30 via the pressing belt 31 is a stacking section.

The detection unit 22 may be detachably provided. The detection unit 22 may be provided in the path between the stacking unit 47 and the heating unit 28. The detection unit 22 detects the amounts of meandering of the first transfer sheet 13 and the second transfer sheet 14. The amounts of meandering are the amounts of misalignment of the first transfer sheet 13 and the second transfer sheet 14 in the width direction. The detection unit 22 may include a first detection unit 49 and a second detection unit 50.

The first detection unit 49 may detect the first transfer sheet 13 overlapping the medium 15. The first detection unit 49 may include a sensor that detects the position of the first transfer sheet 13. The first detection unit 49 may detect the amount of meandering of the first transfer sheet 13 in relation to the medium 15.

The second detection unit 50 may detect the second transfer sheet 14 overlapping the medium 15. The second detection unit 50 may include a sensor that detects the position of the second transfer sheet 14. The second detection unit 50 may detect the amount of meandering of the second transfer sheet 14 in relation to the medium 15.

The first adjustment unit 23 adjusts the position of the first transfer sheet 13. The first adjustment unit 23 may adjust the position of the first transfer sheet 13 by changing the position of the first roll body 37. The first adjustment unit 23 may adjust the position of the first transfer sheet 13 by tilting the first conveyance roller 45 located upstream of the transfer unit 18 in the conveyance direction D.

The second adjustment unit 24 adjusts the position of the second transfer sheet 14. The second adjustment unit 24 may adjust the position of the second transfer sheet 14 by changing the position of the second roll body 38. The second adjustment unit 24 may adjust the position of the second transfer sheet 14 by tilting the second conveyance roller 46 located upstream of the transfer unit 18 in the conveyance direction D. The second adjustment unit 24 may tilt one second conveyance roller 46 located upstream of the transfer unit 18, or may tilt a plurality of second conveyance rollers 46.

The control unit 25 comprehensively controls the driving of each mechanism in the transfer machine 11 and controls various operations executed by the transfer machine 11. The control unit 25 controls the first adjustment unit 23 and the second adjustment unit 24.

The control unit 25 can be configured as a circuit including α: one or more processors that execute various kinds of processing according to a computer program, β: one or more dedicated hardware circuits that execute at least some of the various kinds of processing, or γ: a combination of α and β. The hardware circuit is, for example, an application specific integrated circuit. The processor includes a CPU and a memory such as a RAM and a ROM, and the memory stores program codes or commands configured to cause the CPU to execute processing. The memory, that is, a computer-readable medium includes any readable medium that can be accessed by a general-purpose or dedicated computer.

### Functions of First Embodiment

Functions of the present embodiment will be described.

The control unit 25 drives the feeding unit 19 and the conveyance unit 21 to convey the first transfer sheet 13, the second transfer sheet 14, and the medium 15 at the same speed. That is, the first feeding unit 33 feeds the first transfer sheet 13 from the first roll body 37. The second feeding unit 34 feeds the second transfer sheet 14 from the second roll body 38. The third feeding unit 35 feeds the medium 15 from the third roll body 39.

The stacking unit 47 stacks the first transfer sheet 13 on the medium 15 such that the first transfer surface 13a faces the front surface 15a of the medium 15. The stacking unit 47 stacks the second transfer sheet 14 on the medium 15 such that the second transfer surface 14a faces the back surface 15b of the medium 15. The stacking unit 47 may stack the second transfer sheet 14 and the medium 15 on the first transfer sheet 13 after stacking the second transfer sheet 14 and the medium 15 on each other. The stacking unit 47 stacks and conveys the first transfer sheet 13, the medium 15, and the second transfer sheet 14 together.

The control unit 25 causes the detection unit 22 to detect the amount of meandering of the first transfer sheet 13 and the second transfer sheet 14 before being heated by the heating unit 28.

When the amount of meandering of the first transfer sheet 13 is larger than a threshold, the control unit 25 drives the first adjustment unit 23. The control unit 25 controls the first adjustment unit 23 to reduce the amount of meandering of the first transfer sheet 13 detected by the detection unit 22.

The first adjustment unit 23 may adjust the position of the first transfer sheet 13 by changing the position of the first roll body 37. The first adjustment unit 23 may move the first roll body 37 in the width direction of the first transfer sheet 13 in accordance with the meandering cycle of the first transfer sheet 13. The first adjustment unit 23 may, at a timing of canceling the misalignment of the first transfer sheet 13 to one side in the width direction, move the first roll body 37 to the other side.

The first adjustment unit 23 may adjust the position of the first transfer sheet 13 by tilting the first conveyance roller 45. The first adjustment unit 23 may tilt the first conveyance roller 45 in accordance with the meandering cycle of the first transfer sheet 13. The first adjustment unit 23 may tilt the first conveyance roller 45 at a timing of canceling the misalignment of the first transfer sheet 13 to one side in the width direction such that the tension applied to the other side of the first transfer sheet 13 is larger than the tension applied to the one side.

The first adjustment unit 23 may switch between moving the first roll body 37 and tilting the first conveyance roller 45 according to the amount of meandering of the first transfer sheet 13. A first threshold is larger than a second threshold. For example, when the amount of meandering of the first transfer sheet 13 is larger than the second threshold, the first adjustment unit 23 may tilt the first conveyance roller 45. When the amount of meandering of the first transfer sheet 13 is larger than the first threshold, the first adjustment unit 23 may move the first roll body 37.

When the amount of meandering of the second transfer sheet 14 is larger than a threshold, the control unit 25 drives the second adjustment unit 24. The control unit 25 controls the second adjustment unit 24 to reduce the amount of meandering of the second transfer sheet 14 detected by the detection unit 22.

The second adjustment unit 24 may adjust the position of the second transfer sheet 14 by changing the position of the second roll body 38. The second adjustment unit 24 may move the second roll body 38 in the width direction of the second transfer sheet 14 in accordance with the meandering cycle of the second transfer sheet 14. The second adjustment unit 24 may adjust the position of the second transfer sheet 14 by tilting the second conveyance roller 46. The second adjustment unit 24 may tilt the second conveyance roller 46 in accordance with the meandering cycle of the second transfer sheet 14. Since the adjustment method by the second adjustment unit 24 is the same as the adjustment method by the first adjustment unit 23, the description thereof will be omitted.

The control unit 25 causes the heating unit 28 to heat the multilayer body 16 in the stacking section. The multilayer body 16 is heated and pressurized in the process of passing between the heating unit 28 and the pressing unit 27. Therefore, the images on the first transfer sheet 13 and the second transfer sheet 14 are transferred to the medium 15.

The control unit 25 causes the collection unit 20 to collect the first transfer sheet 13, the second transfer sheet 14, and the medium 15. The multilayer body 16 after the transfer is separated into the first transfer sheet 13, the second transfer sheet 14, and the medium 15, which are then wound up by the first take-up unit 41, the second take-up unit 42, and the third take-up unit 43, respectively.

### Effects of First Embodiment

Effects of the present embodiment will be described.

(1-1) When the first transfer sheet 13 widely meanders, the misalignment of the first transfer sheet 13 increases. When the second transfer sheet 14 widely meanders, the misalignment of the second transfer sheet 14 increases. In this regard, the detection unit 22 detects the amounts of meandering of the first transfer sheet 13 and the second transfer sheet 14. Therefore, the misalignment of the first transfer sheet 13 and the second transfer sheet 14 can be detected.

(1-2) The misalignment of the image transferred to the medium 15 occurs when the first transfer sheet 13 and the second transfer sheet 14 are misaligned in relation to the medium 15. In this regard, the detection unit 22 detects the amount of meandering of the first transfer sheet 13 and the second transfer sheet 14 in relation to the medium 15. Therefore, the misalignment of the image transferred to the medium 15 can be detected.

(1-3) The control unit 25 controls the first adjustment unit 23 to reduce the amount of meandering of the first transfer sheet 13. The control unit 25 controls the second adjustment unit 24 to reduce the amount of meandering of the second transfer sheet 14. Therefore, even when the first transfer sheet 13 and the second transfer sheet 14 meander, the meandering can be corrected.

(1-4) The first adjustment unit 23 changes the position of the first roll body 37. The second adjustment unit 24 changes the position of the second roll body 38. Therefore, even when the amounts of meandering of the first transfer sheet 13 and the second transfer sheet 14 are large, the meandering can be corrected.

(1-5) The first adjustment unit 23 tilts the first conveyance roller 45. The first transfer sheet 13 is wound around the first conveyance roller 45. Therefore, when the tilt of the first conveyance roller 45 changes, a difference occurs between the tension applied to one end side and the tension applied to the other end side of the first transfer sheet 13. That is, the first adjustment unit 23 can accurately adjust the position of the first transfer sheet 13 by varying the tension applied to the first transfer sheet 13. Similarly, the second adjustment unit 24 can accurately adjust the position of the second transfer sheet 14 by tilting the second conveyance roller 46.

(1-6) For example, when the stacking unit 47 and the heating unit 28 sandwich the first transfer sheet 13, the medium 15, and the second transfer sheet 14, the image is transferred to the medium 15 before the meandering is corrected. In this regard, the detection unit 22 is provided in the path between the stacking unit 47 and the heating unit 28. That is, since the stacking unit 47 is provided at a position away from the heating unit 28, the image can be easily transferred to the medium 15 after the meandering is corrected.

(1-7) The detection unit 22 is detachable. Therefore, for example, when the detection accuracy of the detection unit 22 decreases, the detection unit 22 can be easily replaced.

(1-8) The pressing unit 27 presses the first transfer sheet 13 and the second transfer sheet 14 sandwiching the medium 15 against the heating unit 28. Applying heat and pressure to the first transfer sheet 13, the medium 15, and the second transfer sheet 14 enables the image to be easily transferred to the medium 15. However, when the first transfer sheet 13, the second transfer sheet 14, and the medium 15 are set in a state where the pressing unit 27 presses the heating unit 28, there is a risk that the transfer sheets and the medium may be misaligned. In this regard, the separation unit 29 separates the heating unit 28 and the pressing unit 27. Therefore, since the first transfer sheet 13, the second transfer sheet 14, and the medium 15 can pass through the gap between the heating unit 28 and the pressing unit 27, the misalignment can be suppressed.

### Second Embodiment

Next, a second embodiment of the transfer machine will be described with reference to the drawings. The second embodiment is different from the first embodiment in the position where the detection unit 22 is provided. Since the other parts of the second embodiment are substantially the same as those of the first embodiment, the same components are denoted by the same reference numerals and a repeated description thereof will be omitted.

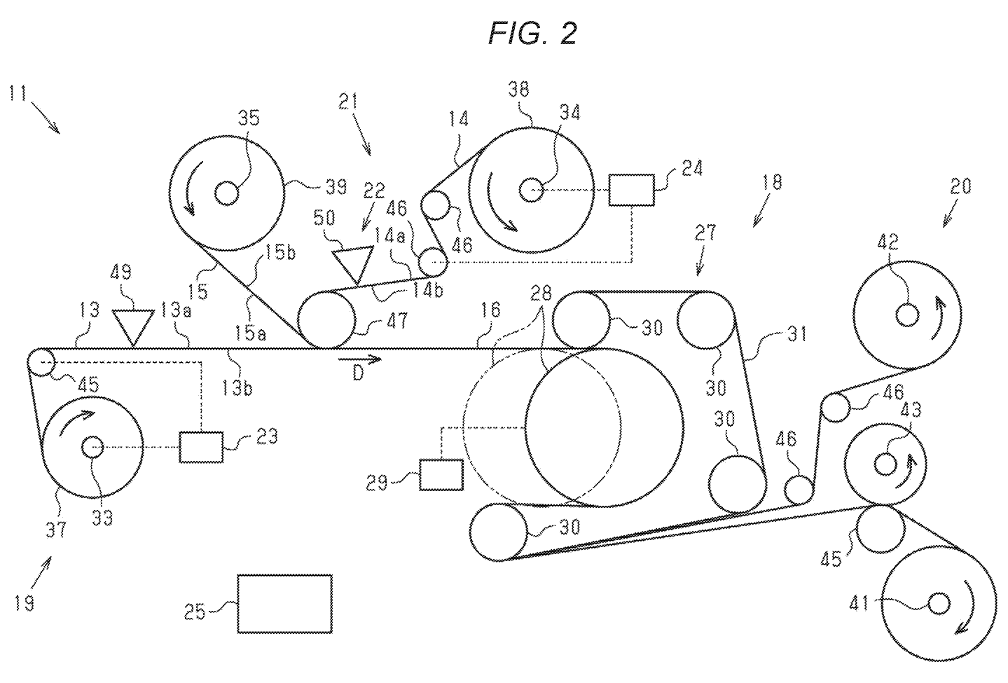

As illustrated in FIG. 2, the detection unit 22 may be provided upstream of the stacking unit 47 in the conveyance direction D.

The first detection unit 49 may detect the first transfer sheet 13 before overlapping the medium 15. The first detection unit 49 may include an image pickup element that picks up an image of the first transfer sheet 13. The first detection unit 49 may analyze the picked-up image. The first detection unit 49 may detect a misalignment of

the first transfer sheet 13 in relation to a reference position. The first detection unit 49 may detect a first mark attached to the first transfer sheet 13 and thus detect the amount of meandering of the first transfer sheet 13. When the first mark is formed of an ink that is not sublimable, the risk of the first mark being transferred to the medium 15 can be reduced.

The second detection unit 50 may detect the second transfer sheet 14 before overlapping the medium 15. The second detection unit 50 may include an image pickup element that picks up an image of the second transfer sheet 14. The second detection unit 50 may analyze the picked-up image. The second detection unit 50 may detect a misalignment of the second transfer sheet 14 in relation to the reference position. The second detection unit 50 may detect a second mark attached to the second transfer sheet 14 and thus detect the amount of meandering of the second transfer sheet 14. When the second mark is formed of an ink that is not sublimable, the risk of the second mark being transferred to the medium 15 can be reduced.

### Effects of Second Embodiment

Effects of the present embodiment will be described.

(2-1) The first mark is attached to the first transfer sheet 13. The second mark is attached to the second transfer sheet 14. The detection unit 22 detects each of the first mark and the second mark. Therefore, the amounts of meandering of the first transfer sheet 13 and the second transfer sheet 14 can be accurately detected.

### Modification Examples

The present embodiment can be implemented with the modifications described below. The present embodiment and the modification examples given below can be implemented in combination with each other as long as no technical inconsistencies are involved.

The detection unit 22 may be fixed to the transfer machine 11.

The conveyance unit 21 may separately include a first stacking unit that stacks the first transfer sheet 13 on the medium 15, and a second stacking unit that stacks the second transfer sheet 14 on the first transfer sheet 13 and the medium 15 that are stacked together. The transfer machine 11 may separately include a second stacking unit that stacks the second transfer sheet 14 on the medium 15, and a first stacking unit that stacks the first transfer sheet 13 on the second transfer sheet 14 and the medium 15 that are stacked together.

The stacking section may be a section in which at least a part of the first path through which the first transfer sheet 13 is conveyed, a part of the second path through which the second transfer sheet 14 is conveyed, and a part of the third path through which the medium 15 is conveyed overlap each other. Specifically, each of the first path, the second path, and the third path may be partially located in the stacking section, or may be entirely located in the stacking section. For example, when the entireties of the first path and the second path are in the stacking section, the first feeding unit 33 and the second feeding unit 34 may sandwich the medium 15 between the first roll body 37 and the second roll body 38. The first take-up unit 41 and the second take-up unit 42 may sandwich the medium 15 between the first transfer sheet 13 and the second transfer sheet 14 that are wound up.

The first adjustment unit 23 may perform one of changing the position of the first roll body 37 and tilting the first conveyance roller 45. When the first adjustment unit 23 changes the position of the first roll body 37, the conveyance unit 21 may not include the first conveyance roller 45.

The second adjustment unit 24 may perform one of changing the position of the second roll body 38 and tilting the second conveyance roller 46. When the second adjustment unit 24 changes the position of the second roll body 38, the conveyance unit 21 may not include the second conveyance roller 46.

In the first embodiment, the first detection unit 49 and the second detection unit 50 may be provided at positions misaligned in the conveyance direction D as long as the positions are between the stacking unit 47 and the transfer unit 18.

In the first embodiment, the detection unit 22 may include one of the first detection unit 49 and the second detection unit 50. For example, the first detection unit 49 may detect the amount of meandering of each of the first transfer sheet 13 and the second transfer sheet 14.

In the first embodiment, at least one of the first detection unit 49 and the second detection unit 50 may include an image pickup element. The image pickup element may pick up an image of the first transfer sheet 13, the second transfer sheet 14, or the multilayer body 16. In the first embodiment and the second embodiment, the detection unit 22 may detect the amounts of meandering of the first transfer sheet 13 and the second transfer sheet 14 by detecting the unevenness or the ends of the first transfer sheet 13 and the second transfer sheet 14. In the second embodiment, the detection unit 22 may detect the image formed on the first transfer sheet 13 or the second transfer sheet 14. The control unit 25 may analyze the picked-up image.

The first transfer sheet 13 may have a first mark attached to the first non-transfer surface 13b. The first detection unit 49 may be provided on the first non-transfer surface 13b side of the first transfer sheet 13.

The second transfer sheet 14 may have a second mark attached to the second non-transfer surface 14b. The second detection unit 50 may be provided on the second non-transfer surface 14b side of the second transfer sheet 14.

In the second embodiment, at least one of the first detection unit 49 and the second detection unit 50 may include a sensor that detects the position of the first transfer sheet 13 or the second transfer sheet 14.

The transfer unit 18 may not include the separation unit 29. The pressing unit 27 may be able to adjust a pressing force for pressing the multilayer body 16 against the heating unit 28. The multilayer body 16 may be set between the heating unit 28 and the pressing unit 27 in a state where the pressing force of the pressing unit 27 is reduced.

The heating unit 28 may be a stand that can support the multilayer body 16. The heating unit 28 may have a heated flat surface. The multilayer body 16 may transfer an image to the medium 15 in a state of being supported on the flat surface.

The first feeding unit 33 may pull out the first transfer sheet 13 from the rotatably supported first roll body 37.

The second feeding unit 34 may pull out the second transfer sheet 14 from the rotatably supported second roll body 38.

The third feeding unit 35 may pull out the medium 15 from the rotatably supported third roll body 39.

The detection unit 22 may notify a device other than the transfer machine 11 of the detected amounts of meandering of the first transfer sheet 13 and the second transfer sheet 14. For example, the detection unit 22 may notify a personal computer, a smartphone, a tablet, or the like of the amounts of meandering. The user may directly adjust the positions of the first transfer sheet 13, the second transfer sheet 14, and the medium 15, based on the notification, or may adjust the positions, using the first adjustment unit 23 and the second adjustment unit 24.

### Definitions

The expression "at least one" used in the present specification means "one or more" of desired options. For example, the expression "at least one" used in the present specification means "only one alternative" or "both of two alternatives" when the number of alternatives is two. As another example, the expression "at least one" used in the present specification means "only one alternative", "a combination of any two alternatives", or "a combination of any three or more alternatives" when the number of alternatives is three or more.

### Appendices

Technical ideas understood from the embodiments and the modification examples described above, and the functions and advantages thereof will hereinafter be described.

[1] There is provided a transfer machine that transfers an image formed on a first transfer surface of a first transfer sheet with a sublimation ink to a front surface of a medium and transfers an image formed on a second transfer surface of a second transfer sheet with a sublimation ink to a back surface of the medium, and the transfer machine includes: a heating unit that heats the first transfer sheet and the second transfer sheet sandwiching the medium in a stacking section in which a first path through which the first transfer sheet is conveyed, a second path through which the second transfer sheet is conveyed, and a third path through which the medium is conveyed overlap each other; and a detection unit that detects an amount of meandering of the first transfer sheet and the second transfer sheet before being heated by the heating unit.

When the first transfer sheet widely meanders, the misalignment of the first transfer sheet increases. When the second transfer sheet meanders largely, the misalignment of the second transfer sheet increases. In this regard, in this configuration, the detection unit detects the amounts of meandering of the first transfer sheet and the second transfer sheet. Therefore, the misalignment of the first transfer sheet and the second transfer sheet can be detected.

[2] In the transfer machine according to the above [1], the detection unit may include a first detection unit and a second detection unit, the first detection unit may detect the first transfer sheet overlapping the medium and thus detect the amount of meandering of the first transfer sheet in relation to the medium, and the second detection unit may detect the second transfer sheet overlapping the medium and thus detect the amount of meandering of the second transfer sheet in relation to the medium.

The misalignment of the image transferred to the medium occurs when the first transfer sheet and the second transfer sheet are misaligned in relation to the medium. In this regard, in this configuration, the detection unit detects the amounts of meandering of the first transfer sheet and the second transfer sheet in relation to the medium. Therefore, the misalignment of the image transferred to the medium can be detected.

[3] The transfer machine according to the above [1] or [2] may further include a first adjustment unit that adjusts a position of the first transfer sheet, a second adjustment unit that adjusts a position of the second transfer sheet, and a control unit that controls the first adjustment unit and the second adjustment unit, and the control unit may control the first adjustment unit such that the amount of meandering of the first transfer sheet detected by the detection unit is reduced, and may control the second adjustment unit such that the amount of meandering of the second transfer sheet detected by the detection unit is reduced.

In this configuration, the control unit controls the first adjustment unit to reduce the amount of meandering of the first transfer sheet. The control unit controls the second adjustment unit to reduce the amount of meandering of the second transfer sheet. Therefore, even when the first transfer sheet and the second transfer sheet meander, the meandering can be corrected.

[4] The transfer machine according to the above [3] may further include a first feeding unit that can hold a first roll body formed of the first transfer sheet before transfer which is wound, and feeds the first transfer sheet from the first roll body, and a second feeding unit that can hold a second roll body formed of the second transfer sheet before transfer which is wound, and feeds the second transfer sheet from the second roll body, in which the first adjustment unit may change the position of the first roll body held by the first feeding unit and thus adjust the position of the first transfer sheet, and the second adjustment unit may change the position of the second roll body held by the second feeding unit and thus adjust the position of the second transfer sheet.

In this configuration, the first adjustment unit changes the position of the first roll body. The second adjustment unit changes the position of the second roll body. Therefore, even when the amounts of meandering of the first transfer sheet and the second transfer sheet are large, the meandering can be corrected.

[5] The transfer machine according to the above [3] or [4] may further include a first conveyance roller around which the first transfer sheet is wound in the first path, and a second conveyance roller around which the second transfer sheet is wound in the second path, in which the first adjustment unit may tilt the first conveyance roller and thus adjust the position of the first transfer sheet, and the second adjustment unit may tilt the second conveyance roller and thus adjust the position of the second transfer sheet.

In this configuration, the first adjustment unit tilts the first conveyance roller. The first transfer sheet is wound around the first conveyance roller. Therefore, when the tilt of the first conveyance roller changes, a difference occurs between the tension applied to one end side and the tension applied to the other end side of the first transfer sheet. That is, the first adjustment unit can accurately adjust the position of the first transfer sheet by varying the tension applied to the first transfer sheet. Similarly, the second adjustment unit can accurately adjust the position of the second transfer sheet by tilting the second conveyance roller.

[6] The transfer machine according to any one of the above [1] to [5] may further include a stacking unit that stacks the first transfer sheet, the medium, and the second transfer sheet, and the detection unit may detect the amount of meandering of the first transfer sheet and the second transfer sheet in a path between the stacking unit and the heating unit in the stacking section.

For example, when the stacking unit and the heating unit sandwich the first transfer sheet, the medium, and the second transfer sheet, the image is transferred to the medium before the meandering is corrected. In this regard, in this configuration, the detection unit is provided in the path between the stacking unit and the heating unit. That is, since the stacking unit is provided at a position away from the heating unit, the image can be easily transferred to the medium after the meandering is corrected.

[7] In the transfer machine according to any one of the above [1] to [6], the detection unit may be detachably provided.

In this configuration, the detection unit is detachable. Therefore, for example, when the detection accuracy of the detection unit decreases, the detection unit can be easily replaced.

[8] In the transfer machine according to any one of the above [1] to [7], the detection unit may detect a first mark attached to the first transfer sheet and thus detect the amount of meandering of the first transfer sheet, and may detect a second mark attached to the second transfer sheet and thus detect the amount of meandering of the second transfer sheet.

In this configuration, the first mark is attached to the first transfer sheet. The second mark is attached to the second transfer sheet. The detection unit detects each of the first mark and the second mark. Therefore, the amounts of meandering of the first transfer sheet and the second transfer sheet can be accurately detected.

[9] The transfer machine according to any one of the above [1] to [8] may include a pressing unit that presses the first transfer sheet and the second transfer sheet sandwiching the medium against the heating unit, and a separation unit that separates the heating unit and the pressing unit.

In this configuration, the pressing unit presses the first transfer sheet and the second transfer sheet sandwiching the medium against the heating unit. Applying heat and pressure to the first transfer sheet, the medium, and the second transfer sheet enables the image to be easily transferred to the medium. However, when the first transfer sheet, the second transfer sheet, and the medium are set in a state where the pressing unit presses the heating unit, there is a risk that the first transfer sheet, the second transfer sheet, and the medium may be misaligned. In this regard, the separation unit separates the heating unit and the pressing unit. Therefore, since the first transfer sheet, the second transfer sheet, and the medium can pass through the gap between the heating unit and the pressing unit, the misalignment can be suppressed.

There is provided a transfer method of transferring an image formed on a first transfer surface of a first transfer sheet with a sublimation ink to a front surface of a medium and transferring an image formed on a second transfer surface of a second transfer sheet with a sublimation ink to a back surface of the medium, and the transfer method includes: heating the first transfer sheet and the second transfer sheet sandwiching the medium in a stacking section in which at least a part of a first path through which the first transfer sheet is conveyed, a part of a second path through which the second transfer sheet is conveyed, and a part of a third path through which the medium is conveyed overlap each other; and detecting an amount of meandering of the first transfer sheet and the second transfer sheet before being heated by a heating unit.

This method has effects similar to those of the transfer machine.

What is claimed is:

1. A transfer machine that transfers an image formed on a first transfer surface of a first transfer sheet with a sublimation ink to a front surface of a medium and transfers an image formed on a second transfer surface of a second transfer sheet with a sublimation ink to a back surface of the medium, the transfer machine comprising:
a heating unit configured to heat the first transfer sheet and the second transfer sheet sandwiching the medium in a stacking section in which a first path through which the first transfer sheet is conveyed, a second path through which the second transfer sheet is conveyed, and a third path through which the medium is conveyed overlap each other; and
a detection unit configured to detect an amount of meandering of the first transfer sheet and the second transfer sheet before being heated by the heating unit.

2. The transfer machine according to claim 1, wherein
the detection unit includes a first detection unit and a second detection unit,
the first detection unit detects the first transfer sheet overlapping the medium and thus detects the amount of meandering of the first transfer sheet in relation to the medium, and
the second detection unit detects the second transfer sheet overlapping the medium and thus detects the amount of meandering of the second transfer sheet in relation to the medium.

3. The transfer machine according to claim 1, further comprising:
a first adjustment unit configured to adjust a position of the first transfer sheet;
a second adjustment unit configured to adjust a position of the second transfer sheet; and
a control unit configured to control the first adjustment unit and the second adjustment unit, wherein
the control unit controls the first adjustment unit such that the amount of meandering of the first transfer sheet detected by the detection unit is reduced, and controls the second adjustment unit such that the amount of meandering of the second transfer sheet detected by the detection unit is reduced.

4. The transfer machine according to claim 3, further comprising:
a first feeding unit configured to be able to hold a first roll body formed of the first transfer sheet before transfer which is wound, and feed the first transfer sheet from the first roll body; and
a second feeding unit configured to be able to hold a second roll body formed of the second transfer sheet before transfer which is wound, and feed the second transfer sheet from the second roll body, wherein
the first adjustment unit changes the position of the first roll body held by the first feeding unit and thus adjusts the position of the first transfer sheet, and
the second adjustment unit changes the position of the second roll body held by the second feeding unit and thus adjusts the position of the second transfer sheet.

5. The transfer machine according to claim 3, further comprising:
a first conveyance roller around which the first transfer sheet is wound in the first path; and
a second conveyance roller around which the second transfer sheet is wound in the second path, wherein
the first adjustment unit tilts the first conveyance roller and thus adjusts the position of the first transfer sheet, and
the second adjustment unit tilts the second conveyance roller and thus adjusts the position of the second transfer sheet.

6. The transfer machine according to claim 3, further comprising:
a stacking unit configured to stack the first transfer sheet, the medium, and the second transfer sheet, wherein
the detection unit detects the amount of meandering of the first transfer sheet and the second transfer sheet in a path between the stacking unit and the heating unit in the stacking section.

7. The transfer machine according to claim 1, wherein
the detection unit is detachably provided.

8. The transfer machine according to claim 1, wherein
the detection unit
detects a first mark attached to the first transfer sheet and thus detects the amount of meandering of the first transfer sheet, and
detects a second mark attached to the second transfer sheet and thus detects the amount of meandering of the second transfer sheet.

9. The transfer machine according to claim 1, further comprising:
a pressing unit configured to press the first transfer sheet and the second transfer sheet sandwiching the medium against the heating unit; and
a separation unit configured to separate the heating unit and the pressing unit.

10. A transfer method of transferring an image formed on a first transfer surface of a first transfer sheet with a sublimation ink to a front surface of a medium and transferring an image formed on a second transfer surface of a second transfer sheet with a sublimation ink to a back surface of the medium, the transfer method comprising:
heating the first transfer sheet and the second transfer sheet sandwiching the medium in a stacking section in which at least a part of a first path through which the first transfer sheet is conveyed, a part of a second path through which the second transfer sheet is conveyed, and a part of a third path through which the medium is conveyed overlap each other; and
detecting an amount of meandering of the first transfer sheet and the second transfer sheet before being heated by a heating unit.
